(19) United States
(12) Patent Application Publication
(10) Pub. No.: US 2026/0150950 A1
(43) Pub. Date: Jun. 4, 2026

(54) MASCARA WARMER

(71) Applicant: JENNIFER TAYLOR, ARGYLE, TX (US)

(72) Inventor: JENNIFER TAYLOR, ARGYLE, TX (US)

(21) Appl. No.: 18/969,004

(22) Filed: Dec. 4, 2024

Related U.S. Application Data
(60) Provisional application No. 63/591,021, filed on Oct. 17, 2023.

(51) Int. Cl. A45D 40/26; A45D 40/00; H05B 3/06

(52) U.S. Cl. CPC A45D 40/26; H05B 3/06; A45D 2040/0006; A45D 2200/157

(57) ABSTRACT

A mascara warmer assembly includes a flexible wrap body configured to surround a mascara tube. The assembly is configured to selectively apply heat to the mascara tube to heat up the contents to allow for better fluidity of the contents and better application to a user. The body includes a plurality of layers with a heating coil located between the layers. A control panel is in communication with the heating coil and is coupled to an external layer of the plurality of layers to be accessible on an external layer of the body when surrounding the mascara tube. The control panel regulates operation of the heating coil. A fastener is coupled to opposing ends of the flexible wrap body so as to keep it in place around the mascara tube. The heating coil is configured to apply heat through the flexible wrap body to the tube.

### CROSS REFERENCE TO RELATED APPLICATIONS

This application claims the benefit of an earlier filing date and right of priority to U.S. Provisional Application No. 63/591,021, filed 17 Oct. 2023, the contents of which is incorporated by reference herein in its entirety.

### BACKGROUND OF THE INVENTION

### 1. Field of the Invention

The present application relates to a beauty device, and more particularly to a warming device for mascara.

### 2. Description of Related Art

Over the years, mascara formulations have improved, with new ingredients and brush designs being introduced to enhance lash length, volume, and curl. Today, mascara has become an essential item in most people's makeup routines, offering a wide range of options to achieve desired lash effects.

One common issue faced by mascara users is the problem of mascara drying out. Mascara typically comes in a liquid or creamy formulation that is applied to the lashes using a brush. However, over time, exposure to air and repeated use can cause the mascara to dry out, leading to clumpy and ineffective application. When mascara dries out, it becomes thick and less fluid, making it difficult to evenly coat the lashes and achieve the desired length and volume. This can result in a less attractive and less satisfying makeup application experience for users.

The drying out of mascara can be attributed to several factors, including air exposure, evaporation of moisture, and the formulation itself. When mascara tubes are repeatedly opened and closed, air enters the tube, causing the product to meet oxygen. This exposure to air leads to the evaporation of the liquid components in the mascara, leaving behind a thicker and less workable consistency. Additionally, certain mascara formulations may be more prone to drying out due to their specific ingredients and composition. The drying out of mascara not only affects its performance but also leads to a shorter shelf life, as users are unable to fully utilize the product before it becomes unusable. Finding a solution to address the issue of mascara drying out is crucial for enhancing the user experience and maximizing the lifespan of mascara products.

Although strides have been made, shortcomings remain. It is desired that an assembly be provided that helps improve the consistency of mascara.

### BRIEF SUMMARY OF THE INVENTION

It is an object of the present application to provide a mascara warmer assembly that is configured to selectively apply heat to a mascara tube. The assembly includes a flexible wrap body configured to surround the mascara tube. The body includes a plurality of layers with a heating coil located between the layers. A control panel is in communication with the heating coil and is coupled to an external layer of the plurality of layers to be accessible on an external layer of the body when surrounding the mascara tube. The control panel regulates operation of the heating coil. A fastener is coupled to opposing ends of the flexible wrap body so as to keep it in place around the mascara tube. The heating coil is configured to apply heat through the flexible wrap body to the tube

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a side view of a mascara warmer wrapped around a mascara tube according to an embodiment of the present application.

FIG. 2 is a partially unwrapped side view of the mascara warmer of FIG. 1.

FIG. 3 is a front view of the mascara warmer of FIG. 2.

FIG. 4 is a rear view of the mascara warmer of FIG. 3.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

The mascara warmer of the present application is configured to address the problem of mascara drying out. It is a portable housing or sleeve specifically designed to accommodate a mascara tube. The mascara warmer features a heating unit with one or more heating elements that work in conjunction to heat up the mascara tube quickly. The user simply places the mascara tube inside the wrap-around sleeve before application and activates the heating unit by switching it on. The heating unit is equipped with a temperature monitor to ensure optimal heating conditions. The external temperature of the mascara tube ranges from 95 to 105 degrees Celsius, while the internal temperature ranges from 85 to 95 degrees Celsius.

This device offers convenience and functionality, allowing users to heat their mascara to the desired temperature for smoother and more effective application. After applying the mascara, the user can turn off the device or rely on the automatic shut-off feature for energy efficiency. To ensure continued usage, the Mascara Warmer requires periodic recharging. The housing or sleeve is made from stretchy materials such as neoprene or polyurethane, providing a secure and snug fit for the mascara tube. With the Mascara Warmer, users can say goodbye to dried-out mascara and enjoy a more pleasant and satisfying makeup application experience.

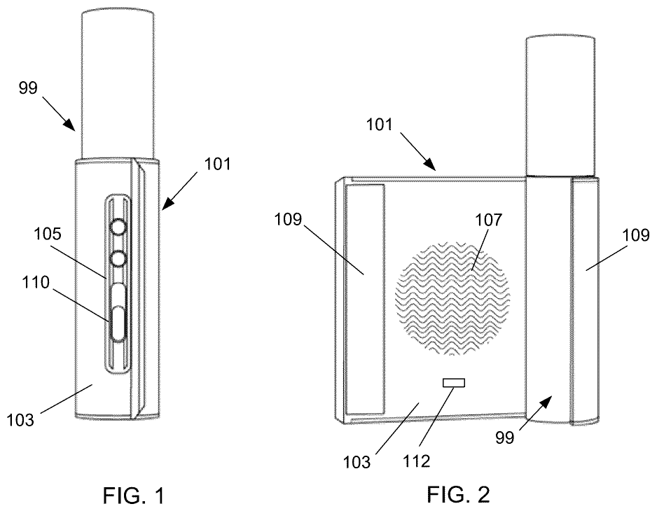

Referring now to FIGS. 1-2 in the drawings, views of mascara warmer 101 is illustrated. Warmer 101 is configured to wrap around a mascara tube 99 and selectively apply heat to the tube so as to increase the temperature and fluidity of the mascara inside it. Warmer 101 includes a flexible wrap body 103 having a plurality of layers, a control panel 105, internal heating coils 107, and a fastener 109. Body 103 is a specially designed housing or wrap around sleeve that accommodates a mascara tube 99. The component is configured to snugly fit around tube 99 ensuring optimal heat transfer from heat coils 107. Body 103 is multilayered so as to provide insulative effect on an outer surface of body 103 such that a user is not injured or affected by the heat coils 107. It is understood that body 103 may include elastic properties so as to allow it to stretch around tube 99. As seen particularly with FIG. 2 in the drawings, fastener 109 is used to secure opposing ends of body 103 around tube 99. Fasteners 109 may include hook and loop fasteners or any other commonly used fastener that allow repeated use of fastening and unfastening.

Control panel 105 is configured to include electronic components and circuitry configured to regulate the distribution of electrical current to heat coils 107. Control panel 105 includes an on off switch 110 along with the capability of lights, buttons, or switches Used to communicate a visual or audible operational condition to the user. For example, lights may be used in illustrate to the user when warmer 101 is heating in an on position or is it off. Control panel 109 may also include a charging port to recharge a battery. It is understood that control panel 109 is ideally situated on an outer surface of body 103 such that when wrapped around tube 99, control panel 105 is visually and functionally accessible to a user.

Control panel 105 may also include the capability of a temperature monitoring system configured to ensure the safe and optimal heating of coils 107. This system may include an external temperature sensor 112 so as to maintain a temperature of 95 to 105 degrees Celsius and an internal temperature range of 85 to 95 degrees Celsius for tube 99. Sensor 112 is located along an internal layer of the flexible wrap body adjacent tube 99. The temperature monitoring system is configured to automatically regulate the amount of electrical energy provided to coils 107 so as to maintain ideal temperatures.

Heating coils 107 may consist of one or more heating elements located within internal layers of body 103. For example, two heating elements may be used to ensure faster and efficient warming of tube 99 and the internally held mascara. Elements 107 are responsible for generating controlled heat to prevent the mascara from drying out and to maintain its desired fluid consistency. It is understood that heating coils 107 may be located throughout any portion of the surface areas of body 103.

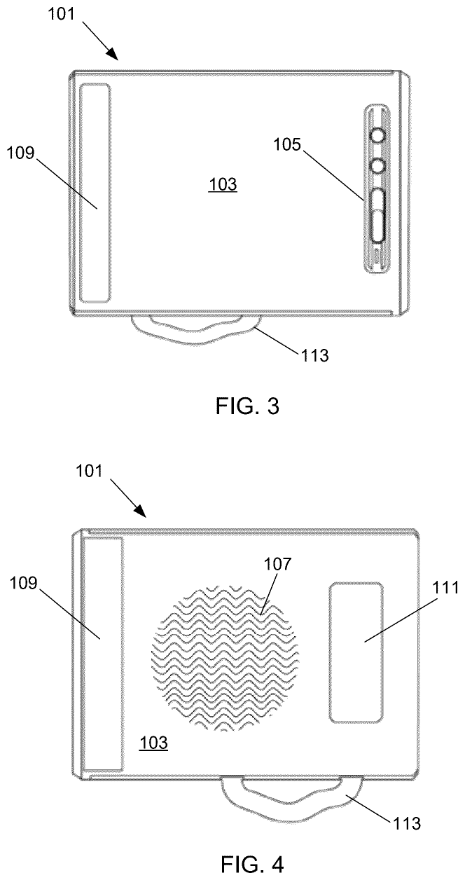

Referring now also to FIGS. 3 and 4 in the drawings, front and rear views of body 103 of warmer 101 is illustrated. In FIG. 3 a front view of body 103 is shown. Control panel 109 is shown on the front or outer surface of body 103. Fastener 109 is shown on the outer surface as well as inner surface seen in figure four. Depending on the type of fastener used, fastener 109 may be located on both surfaces.

Also seen in FIG. 4 is power supply 111. Power supply 111 includes a battery, which may be a lithium-ion battery or other type as commonly used in the yard. Power supply 111 is located partially within body 103 so as to include at least a partial covering that may be similar to the outer surface of body 103. Power supply 111 is in communication with control panel 105 and is configured to transfer electrical energy 2 control panel 105 and also receive electrical energy therefrom through a charging port. Ideally power supply 111 is flush with the internal surface of body 103 as such surface makes contact adjacent tube 99.

Additionally, coils 107 are shown in figure four. Coils 107 may be situated closer to inner surface of body 103 as opposed to the outer surface of body 103. Coils 107 are configured to transfer heat to tube 99 within a given temperature range. Also seen in the Figures is a band 113, which may be elastic in nature, configured to prevent tube 99 from slipping out from body 103. Once warmer 101 is wrapped around tube 99 come up band 113 is situated beneath tube 99 to prevent it from translating out.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A mascara warmer assembly, comprising:
a flexible wrap body having a plurality of layers
a heating coil located within the plurality of layers;
a control panel in communication with the heating coil, the control panel coupled to a layer of the plurality of layers and is configured to regulate operation of the heating coil;
a fastener coupled to opposing end of the flexible wrap body, the fastener configured to selectively couple the opposing ends together;
wherein the heating coil is configured to apply heat through the flexible wrap body.

2. The assembly of claim 1, further comprising:
a mascara tube, the flexible wrap body configured to wrap around the mascara tube and the heating coil configured to heat up the mascara tube.

3. The assembly of claim 2, wherein the fastener is configured to join opposing ends of the flexible rap body around the mascara tube.

4. The assembly of claim 2, wherein an outer layer of the plurality of layers of the flexible wrap is configured to be insulative so as to help trap heat from the heating coil.

5. The assembly of claim 2, wherein an outer layer of the plurality of layers of the flexible wrap is configured to be more insulative than an inner layer of the plurality of layers.

6. The assembly of claim 2, wherein an outer surface of the mascara tube is heated to a range of 95 to 105 degrees Celsius.

7. The assembly of claim 2, wherein the mascara tube has an internal temperature range of 85 to 95 degrees Celsius from the heat generated by the heating coil.

8. The assembly of claim 2, further comprising:
a temperature sensor located on a layer of the flexible wrap body adjacent to the mascara tube, the temperature sensor configured to monitor an external temperature of the mascara tube.

9. The assembly of claim 1, wherein one of the plurality of layers of the flexible wrap body is configured to provide an insulative effect to aid in retaining heat from the heating coil.

10. The assembly of claim 1, wherein the control panel includes a power supply to selectively provide power to the heating coil.

11. The assembly of claim 10, wherein the control panel is rechargeable.

12. The assembly of claim 1, wherein the control panel includes an on/off switch.

13. The assembly of claim 1, wherein the heating coil is automatically shut off by the control panel after a set time.

14. The assembly of claim 1, wherein the fastener is a hook and loop fastener.

15. The assembly of claim 1, further comprising:
a band extending from a side edge of the flexible wrap body.
